(19) United States
(12) Patent Application Publication
(10) Pub. No.: US 2010/0261818 A1
(43) Pub. Date: Oct. 14, 2010

(54) FLAME-RETARDANT POLYAMIDE COMPOSITION

(75) Inventor: Masashi Seki, Chiba (JP)

Correspondence Address: BUCHANAN, INGERSOLL & ROONEY PC, POST OFFICE BOX 1404, ALEXANDRIA, VA, 22313-1404, US

(73) Assignee: MITSUI CHEMICALS, INC., Minato-ku (JP)

(21) Appl. No.: 12/678,439

(22) PCT Filed: Sep. 19, 2008
(86) PCT No.: PCT/JP2008/002600

§ 371 Date: Mar. 16, 2010

(30) Foreign Application Priority Data
Sep. 21, 2007 (JP) 2007-244695

(51) Int. Cl. C08K 5/5399; B29C 45/00

(52) U.S. Cl. 524/116; 524/122; 264/85

(57) ABSTRACT

Disclosed is a flame-retardant polyamide composition which has excellent mechanical properties such as toughness, excellent heat resistance and flow ability during reflow soldering, and good thermal stability during molding, without using a halogen flame-retardant. This flame-retardant polyamide composition exhibits stable flame retardance particularly when a thin article is molded. Specifically disclosed is a flame-retardant polyamide composition containing 20-80% by mass of a specific polyamide resin (A), 5-30% by mass of a phosphinate compound (B), and 0.01-10% by mass of a phosphazene compound (C).

### TECHNICAL FIELD

The present invention relates to a halogen-free, flame-retardant polyamide composition which has excellent physical properties (e.g., toughness), high heat resistance during a reflow soldering process, high flow ability, high thermal stability during molding and, particularly when molded into a thin article, high flame retardancy.

More specifically, the present invention relates to an environmentally friendly polyamide composition suitable in applications where an electrical part such as a thin and fine pitch connector is fabricated and surface-mounted using a high-melting point lead-free solder.

### BACKGROUND ART

As materials for electric parts, polyamide resins have been used that can be molded into desired shape by heat melting. In general, polyamides such as Nylon 6 and Nylon 66 are used in many fields. These aliphatic polyamides generally have excellent moldability, but are insufficient in heat resistance as materials for surface-mount components such as connectors, which are exposed to high temperatures as in a reflow soldering process. Against the backdrop of this situation, Nylon 46 was developed as a polyamide with high heat resistance, but it has the disadvantage of high water absorbency. For this reason, electric parts molded of a Nylon 46 resin composition may undergo size change due to water absorption. Moreover, when a molded article of the Nylon 46 resin composition has absorbed water and is then heated in a reflow soldering process, unwanted “blisters” occur in the article. To avoid environmental problems, particularly in recent years, surface-mounting schemes using lead-free solders have been increasingly employed. As lead-free solders have higher melting points than conventional lead-based solders, the mounting temperature must be increased by 10-20° C. than before, making the use of Nylon 46 more and more difficult.

To overcome this problem aromatic polyamides were developed, which are the polycondensates of aromatic dicarboxylic acids (e.g., terephthalic acid) and aliphatic alkylene diamines. Aromatic polyamides have higher heat resistance and lower water absorbency than aliphatic polyamides such as Nylon 46. Aromatic polyamides may be made to have higher rigidity than Nylon 46, but have the disadvantage of insufficient toughness. In particular, if the material of a thin and fine pitch connector is insufficient in toughness, it may result in cracking and/or clouding in the product when the terminals are pressed into or plucked from a device. Therefore, there is an increasing need for materials with much higher toughness.

Toughness can be enhanced by increasing the polyamide resin proportion and reducing the flame retardant proportion. However, electric parts like connectors are often required to have high flame retardancy and flame resistance sufficient to meet the Underwriters Laboratories (UL) 94 V-0 requirements. Therefore, it has been difficult to achieve high toughness without impairing flame retardancy.

Amid growing concerns for global warming, halogen-containing flame retardants such as brominated polyphenylene ether, brominated polystyrene and polybrominated styrene are typically used. As halogen compounds generate toxic halogenated hydrogen gas when burned, development of halogen-free flame retardants with high heat resistance has been considered imperative. For development of such flame retardants, attention is directed to the use of phosphinates.

However, in applications for electric parts where thin and small molded articles are often used, phosphinates cannot provide a thin molded article ( 1/32 inch or less in thickness) with flame retardancy sufficient to meet the Underwriters Laboratories (UL) 94 V-0 requirements. Moreover, in this case, flow ability during molding is poor.

Patent Document 1 discloses a polyamide composition whose flame retardancy meets the UL 94 V-0 requirements. However, unfortunately, thin molded articles, e.g., 1/32 inch-thick molded articles made of the polyamide composition offer different degrees of flame retardancy; burning time greatly varies from one flame retardancy test to another.

Patent Documents 2 and 3 relate to a technology in which as a flame-retardant component an adduct of melamine with phosphoric acid is used together with a metal compound. However, the adduct offers low heat resistance and thus causes such problems as decomposition during extrusion molding, virtually prohibiting its use particularly in high-melting point heat resistance polyamide resins which are to be processed at 280° C. or higher.

Patent Document 4 discloses using at least one compound selected from phosphazenes and phosphinates as a flame-retardant component. However, in this document, only phosphazenes are virtually used as a flame-retardant component. There is a large difference in melting point between phosphazene and high-melting point polyamide resin with a melting point of 280° C. or higher (particularly 310° C. or higher). This causes large reduction in kneadability of an extruder or the like, as well as difficulty in ensuring high flame retardancy comparable to the UL 94 V-0 requirements in 1/32 inch-thick molded articled.

Patent Document 5 proposes a composition which can contain as a flame retardant a phosphazene and as a flame retardant synergist an organic phosphinic acid compound in a resin like a polyamide resin. However, this composition similarly raises problems of kneadability reduction of an extruder or the like, flow ability reduction, gas generation during molding, etc.

Patent Document 1: WO2005/035664

Patent Document 2: Japanese Patent Application Laid-Open No. 2007-023206

Patent Document 3: Japanese Patent Application Laid-Open No. 2007-023207

Patent Document 4: Japanese Patent Application Laid-Open No. 2007-138151

Patent Document 5: Japanese Patent Application Laid-Open No. 2003-342482

### DISCLOSURE OF INVENTION

### Problems to be Solved by the Invention

It is an object of the present invention to provide a halogen-free, flame-retardant polyamide resin which generates no halogen compounds when burned. The flame-retardant polyamide resin exhibits excellent thermal stability during high-temperature molding and can exert stable flame retardancy when burned. Moreover, the flame-retardant polyamide resin is excellent in flow ability, toughness, and heat resistance during a reflow soldering process for surface mounting using a lead-free solder.

### Means for Solving the Problem

In light of the foregoing situation, the inventor conducted extensive studies and completed the present invention by establishing that a flame-retardant polyamide composition which contains a polyamide resin, a phosphinate, a phosphazene, and optionally as a flame retardant synergist an oxide of a specific element is excellent in molding stability, flame retardancy, flow ability and toughness as well as in heat resistance during a reflow soldering process for surface mounting using a lead-free solder.

Specifically, the present invention provides a flame-retardant polyamide composition, a molded article thereof, a molding method thereof and an electric part thereof, wherein the flame-retardant polyamide composition contains 20-80 wt % polyamide resin (A), 5-30 wt % phosphinate (B), and 0.01-10 wt % phosphazene (C).

### ADVANTAGEOUS EFFECT OF THE INVENTION

A flame-retardant polyamide composition of the present invention generates no halogen compounds when burned. Furthermore, the flame-retardant polyamide composition exhibits excellent thermal stability during molding, exerts stable flame retardancy when formed in a thin molded article, and is excellent in flow ability and toughness. The flame-retardant polyamide composition can provide a molded article with high heat resistance sufficient to endure a reflow soldering process for surface mounting using a lead-free solder. Thus, the flame-retardant polyamide composition is of high industrial value.

### BRIEF DESCRIPTION OF DRAWINGS

FIG. 1 shows a graph of reflow process temperature vs. reflow process time in reflow heat resistance tests conducted in Examples and Comparative Examples;

FIG. 2 is a table (Table 1) which shows the results of Examples;

FIG. 3 is a table (Table 2) which shows the results of Examples and Comparative Examples;

FIG. 4 is a table (Table 3) which shows the results of Examples; and

FIG. 5 is a table (Table 4) which shows the results of Examples and Comparative Examples.

### BEST MODE FOR CARRYING OUT THE INVENTION

Hereinafter, the present invention will be described in detail.

### [Polyamide Resin (A)]

A flame-retardant polyamide composition of the present invention is composed of multifunctional carboxylic acid unit (a-1) and multifunctional amine unit (a-2).

[Multifunctional Carboxylic Acid Unit (a-1)]

The multifunctional carboxylic acid unit (a-1) constituting polyamide resin (A) is preferably composed of 40-100 mol % terephtalic acid unit, 0-30 mol % multifunctional aromatic carboxylic acid unit other than terephtalic acid, and/or 0-60 mol % multifunctional aliphatic carboxylic acid unit having 4-20 carbon atoms, based on the total amount of the multifunctional carboxylic acid units.

Examples of the multifunctional aromatic carboxylic acid unit other than terephthalic acid include isophthalic acid, 2-methyl terephthalic acid, naphthalene dicarboxylic acid, phthalic anhydride, trimellitic acid, pyromellitic acid, trimellitic anhydride, and pyromellitic anhydride, with isophthalic acid being particularly preferable. These carboxylic acids may be used alone or in combination. When a carboxylic acid unit having three or more functional groups is used, the contained amount thereof should adjusted so as to avoid gellation of resin. More specifically, it needs to be contained in an amount of not greater than 10 mol % based on the total amount of the carboxylic acid units.

When a multifunctional aliphatic carboxylic acid unit is to be introduced, it is derived from a multifunctional aliphatic carboxylic acid having 4-20 carbon atoms, preferably 6-12 carbon atoms, more preferably 6-10 carbon atoms. Examples of the multifunctional aliphatic carboxylic acid include adipic acid, suberic acid, azelaic acid, sebacic acid, decanedicarboxylic acid, undecanedicarboxylic acid, and dodecanedicarboxylic acid. Among them, adipic acid is particularly preferable in view of improving mechanical properties. Where necessary, it is possible to further add a carboxylic acid having three or more functional groups; however, the contained amount thereof should be adjusted so as to avoid gellation of the resin. More specifically, it needs to be contained in an amount of not greater than 10 mol % based on the total amount of the carboxylic acid units.

The amount of the terephthalic acid unit is 40-100 mol %, preferably 50-100 mol %, more preferably 60-100 mol %, further preferably 60-70 mol %, based on the total amount of the multifunctional carboxylic acid units. The amount of the multifunctional aromatic carboxylic acid unit other than terephthalic acid is 0-30 mol %, preferably 0-10 mol %, based on the total amount of the multifunctional carboxylic acid units. When the amount of the multifunctional aromatic carboxylic acid unit is large, the polyamide resin tends to show reduced moisture absorption and increased reflow heat resistance. The amount of the terephthalic acid unit is preferably 60 mol % or more particularly where a reflow soldering process using lead-free solders is employed. The crystallinity of the polyamide resin increases as the amount of the multifunctional aromatic carboxylic acid unit other than terephthalic acid unit decreases; therefore, when the amount of the multifunctional aromatic carboxylic acid unit other than terephthalic acid unit is small, the resultant molded article tends to have excellent mechanical properties, particularly toughness. The amount of the multifunctional aliphatic carboxylic acid unit having 4-20 carbon atoms is 0-60 mol %, preferably 0-50 mol %, more preferably 30-40 mol %.

[Multifunctional Amine Unit (a-2)]

The multifunctional amine unit (a-2) constituting polyamide resin (A) may be a linear and/or side chain-containing multifunctional amine unit having 4-25 carbon atoms, preferably a linear and/or side chain-containing multifunctional amine unit having 4-8 carbon atoms, more preferably a linear multifunctional amine unit having 4-8 carbon atoms. The total amount of these amine units constitutes 100 mol % of the multifunctional amine unit (a-2).

Specific examples of the linear multifunctional amine unit include 1,4-diaminobutane, 1,6-diaminohexane, 1,7-diaminoheptane, 1,8-diaminooctaone, 1,9-diaminononane, 1,10-diaminodecane, 1,11-diaminoundecane, and 1,12-diaminododecane. Among them, 1,6-diaminohexane is preferable.

Specific examples of the multifunctional aliphatic amine unit having a side chain include 2-methyl-1,5-diaminopentane, 2-methyl-1,6-diaminohexane, 2-methyl-1,7-diaminoheptane, 2-methyl-1,8-diaminooctane, 2-methyl-1,9-diaminononane, 2-methyl-1,10-diaminodecane, and 2-methyl-1,11-diaminoundecane. Among them, 2-methyl-1,5-diaminopentane and 2-methyl-1,8-diaminooctane are preferable.

Examples of multifunctional alicyclic amine unit include units derived from alicyclic diamines such as 1,3-di aminocyclohexane, 1,4-diaminocyclohexane, 1,3-bis(aminomethyl)cyclohexane, 1,4-bis(aminomethyl)cyclohexane, isophoronediamine, piperazine, 2,5-dimethylpiperazine, bis(4-aminocyclohexyl)methane, bis(4-aminocyclohexyl)propane, 4,4′-diamino-3,3′-dimethyldicyclohexylpropane, 4,4′-diamino-3,3′-dimethyldicyclohexylmethane, 4,4′-diamino-3,3′-dimethyl-5,5′-dimethyldicyclohexylmethane, 4,4′-diamino-3,3′-dimethyl-5,5′-dimethyldicyclohexylpropane, α,α′-bis(4-aminocyclohexyl)-p-diisopropylbenzene, α,α′-bis(4-aminocyclohexyl)-m-diisopropylbenzene, α,α′-bis(4-aminocyclohexyl)-1,4-cyclohexane, and α,α′-bis(4-aminocyclohexyl)-1,3-cyclohexane. Among them, units derived from alicyclic diamines such as 1,3-diaminocyclohexane, 1,4-diaminocyclohexane, bis(aminomethyl)cyclohexane, bis(4-aminocyclohexyl)methane, and 4,4′-diamino-3,3′-dimethyldicyclohexylmethane are preferable, with 1,3-diaminocyclohexane, 1,4-diaminocyclohexane, bis(4-aminocyclohexyl)methane, 1,3-bis(aminohexyl)methane, 1,3-bis(aminomethyl)cyclohexane being most preferable. When an amine compound having three or more functional groups is used, the contained amount thereof should be adjusted so as to avoid gellation of resin. More specifically, it needs to be contained in an amount of not greater than 10 mol % based on the total amount of the amine units.

Properties of Polyamide Resin(A)

Polyamide resin (A) used in the present invention has an intrinsic viscosity [η] of 0.5-1.25 dl/g, preferably 0.65-0.95 dl/g, more preferably 0.75-0.90 dl/g, as measured in 96.5% sulfuric acid at 25° C. When the intrinsic viscosity falls within the range, it is possible to obtain a polyamide resin having excellent flow ability, reflow heat resistance, and toughness.

Further, polyamide resin (A) is crystalline and therefore has a melting point (Tm). The melting point of polyamide resin (A) is preferably 280-340° C., more preferably 300-340° C., further preferably 315-330° C. The melting point is defined as a temperature corresponding to an endothermic peak in a differential scanning calorimetry (DSC) curve, which is obtained by heating polyamide resin (A) at a heating rate of 10° C./min using a differential scanning calorimeter. Polyamide resins having melting points falling within the range exhibit particularly excellent heat resistance. Moreover, when the melting point is 280° C. or above, 300° C. or above, particularly within 315-330° C., sufficient heat resistance can be imparted to a molded article produced from the polyamide composition even in a lead-free reflow soldering process, particularly in a reflow soldering process using lead-free solder with a high melting point. On the other hand, when the melting point of the polyamide resin is below 340° C., which is below the decomposition temperature of polyamide (350° C.), molding can be carried out without causing such problems as generation of foams or decomposition gas and color changes of the molded article, thereby resulting sufficient thermal stability.

Polyamide resin (A) used in the present invention is contained in an amount of 20-80 wt %, preferably 40-60 wt %, based on the weight of a flame-retardant polyamide composition.

[Phosphinate (B)]

Phosphinate (B) used in the present invention is a component added to reduce flammability of resin. Preferable examples thereof include metal phosphinates. Representative examples are compounds having the following formula (3) and/or formula 4).

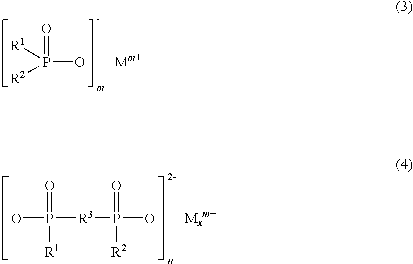

(where R¹ and R² are the same or different and each denote a linear or branched C₁-C₆ alkyl and/or aryl group; R³ denotes a linear or branched C₁-C₁₀ alkylene group, C₆-C₁₀ arylene group, C₆-C₁₀ alkylarylene group or C₆-C₁₀ arylalkylene group; M denotes Mg, Ca, Al, Sb, Sn, Ge, Ti, Zn, Fe, Zr, Ce, Bi, Sr, Mn, Li, Na, K and/or protonated nitrogen base; m denotes an integer of 1-4; n denotes an integer of 1-4; and x denotes an integer of 1-4)

Additional specific examples of phosphinates include calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphosphinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate, zinc methyl-n-propylphosphinate, calcium methanedi(methylphosphinate), magnesium methanedi(methylphosphinate), aluminum methanedi(methylphosphinate), zinc methanedi(methylphosphinate), calcium benzene-1,4-(dimethylphosphinate), magnesium benzene-1,4-(dimethylphosphinate), aluminum benzene-1,4-(dimethylphosphinate), zinc benzene-1,4-(dimethylphosphinate), calcium methylphenylphosphinate, magnesium methylphenylphosphinate, aluminum methylphenylphosphinate, zinc methylphenylphosphinate, calcium diphenylphosphinate, magnesium diphenylphosphinate, aluminum diphenylphosphinate, and zinc diphenylphosphinate. Among them, calcium dimethylphosphinate, aluminum dimethylphosphinate, zinc dimethylphosphinate, calcium ethylmethylphosphinate, aluminum ethylmethylphosphinate, zinc ethylmethylphosphinate, calcium diethylphosphinate, aluminum diethylphosphinate, and zinc diethylphosphinate are preferable, with aluminum diethylphosphinate being further preferable.

Phosphinate (B) in the present invention is readily commercially available. Examples of commercially available phosphinates include EXOLIT OP1230 and EXOLIT OP930 (Clariant (Japan) K.K.)

Phosphinate (B) is preferably added in an amount of 5-30 wt %, more preferably 10-20 wt %, based on the weight of a flame-retardant polyamide composition.

When phosphinate (B) is used in an amount falling within the range, it is possible for a polyamide composition to have high and stable flame retardancy comparable to UL94V-0. Furthermore, the polyamide composition has high flow ability that allows the composition to be formed into a thin molded article, excellent mechanical properties such as toughness, and sufficient heat resistance during a reflow soldering process, particularly during a reflow soldering process where high-melting point lead-free solder is used.

[Phosphazene (C)]

Phosphazene (C) in the present invention is a component used for the purpose of achieving both high flow ability and high flame retardancy which is sufficient to meet UL94V-0, without impairing mechanical properties such as toughness particularly in the case of fabricating a thin molded article ( 1/32 inch or less in thickness). Phosphazene (C) is particularly effective in applications such as manufacturing of thin and small electric parts.

Phosphazene (C) is at least one phosphazene selected from a cyclic phosphazene having the following formula (1), a linear phosphazene having the following formula (2), and at least one phosphazene obtained by cross-linking the cyclic phosphazene or the linear phosphazene with a cross-linking group.

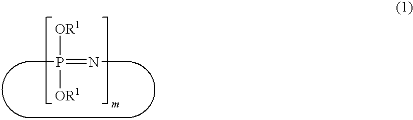

(where m denotes an integer of 3-25; and R¹s are the same or different and each denote an aryl group or alkylaryl group, and the ratio of alkylaryl group is 0.1-100 mol % based on the total amount of R¹s)

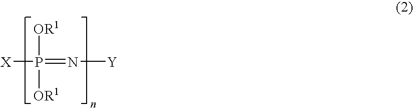

(where n denotes an integer of 3-10,000; X denotes —N═P(OR¹)₃ or —N═P(O)OR¹; Y denotes —P(OR¹)₄ or —P(O)(OR¹)₂; and R¹s are the same or different and each denote an aryl group or alkylaryl group, and the ratio of alkylaryl group is 0.1-100 mol % based on the total amount of R¹s)

Examples of the alkylaryl group denoted by R¹ in the formulas (1) and (2) include (C₁₋₁₀)alkyl(C₆₋₂₀)aryl groups such as tolyls (e.g., o-tolyl, m-tolyl and p-tolyl); xylyls (e.g., 3,4-xylyl, 3,5-xylyl, 2,3-xylyl, 2,4-xylyl, 2,5-xylyl and 2,6-xylyl); ethylphenyls; cumyls (e.g., o-cumyl, m-cumyl, p-cumyl and phenylcumyl); butylphenyls (e.g., 2-t-butylphenyl, 4-t-butylphenyl, 2,4-di-t-butylphenyl, 2,6-di-t-butylphenyl, 3-methyl-6-t-butylphenyl and 2,6-di-t-butyl-4-methylphenyl); aminophenyls (e.g., 2,4-di-t-aminophenyl and 2,6-di-t-aminophenyl); cyclohexylphenyls; trimethylphenyls; and methylnaphthyls. Preferred examples are (C₁₋₃)alkylphenyls such as o-tolyl, m-tolyl, p-tolyl, 2,4-xylyl, 2,6-xylyl and 3,5-xylyl.

Examples of the aryl group denoted by R¹ include C6-20 aryl groups such as phenyl; naphthyl; biphenylyls (e.g., o-phenylphenyl, m-phenylphenyl and p-phenylphenyl); alkoxyphenyls (e.g., o-methoxyphenyl, m-methoxyphenyl and p-methoxyphenyl); hydroxyphenyls (e.g., o-hydroxyphenyl, m-hydroxyphenyl, p-hydroxyphenyl and p-(p′-hydroxyphenyl)phenyl); (hydroxyaryl)alkylaryls (e.g., p-[2-(p′-hydroxyphenyl)isopropyl]phenyl); (hydroxyarylsulfonyl)aryls (e.g., p-(p′-hydroxyphenylsulfonyl)phenyl); (hydroxyaryloxy)aryls (e.g., p-(p′-hydroxyphenyloxy)phenyl); glycidylphenyl, and cyanophenyl. Generally, R¹ denotes phenyl or cyano phenyl group.

Examples of cyclic and/or linear phosphazenes having formula (1) or (2) include cyclic and/or linear (C₁₋₆)alkyl(C₆₋₂₀)aryloxyphosphazenes such as (poly)tolylphosphazenes (e.g., o-tolyloxyphosphazene, m-tolyloxyphosphazene, p-tolyloxyphosphazene, o,m-tolyloxyphosphazene, o,p-tolyloxyphosphazene, m,p-tolyloxyphosphazene and o,m,p-tolyloxyphosphazene), (poly)xylyloxyphosphazenes, and (poly)methylnaphthyloxyphosphazenes; and cyclic and/or linear (C₆₋₂₀)aryl(C₁₋₁₀)alkyl(C₆₋₂₀)aryloxyphosphazenes such as (poly)phenoxytolyloxyphosphazenes (e.g., phenoxy-o-tolyloxyphosphazene, phenoxy-m-tolyloxyphosphazene, phenoxy-p-tolyloxyphosphazene, phenoxy-o,m-tolyloxyphosphazene, phenoxy-o,p-tolyloxyphosphazene, phenoxy-m,p-tolyloxyphosphazene and phenoxy-o,m,p-tolyloxyphosphazene), (poly)phenoxyxylyloxyphosphazenes, (poly)phenoxytolyloxyxylyloxyphosphazenes, and (poly)phenoxymethylnaphthyloxyphosphazenes. Preferred examples are cyclic and/or linear (C₁₋₃)alkyl(C₆₋₂₀)aryloxyphosphazenes, (C₆₋₂₀)aryloxy(C₁₋₃)alkyl(C₆₋₂₀)aryloxyphosphazenes (e.g., cyclic and/or linear tolyloxyphosphazenes and cyclic and/or linear phenoxytolylphenoxyphosphazenes, particularly cyclic tolyloxyphosphazenes and cyclic phenoxytolyloxyphosphazenes).

Phosphazene (C) used in the present invention also encompasses cross-linked phosphazenes obtained by cross-linking at least one kind of phosphazene selected from the above cyclic phosphazene having formula (1) and linear phosphazene having formula (2) with a cross-linking group. When a pair of phosphazenes is to be cross-linked by a cross-linking group, a divalent cross-linking group is introduced instead of a pair of R¹s.

The cross-linking group may be an alkylene or cycloalkylene group, but is generally an arylene group. Examples of the arylene group include phenylenes (e.g., 1,2-phenylene, 1,3-phenylene and 1,4-phenylene); naphthylenes; biphenylenes (e.g., 4,4′-biphenylene and 3,3′-biphenylene); and bisphenol residues (e.g., 1,4-phenyleneisopropylidene-1,4-phenylene (bisphenol A residue), 1,4-phenylenemethylene-1,4-phenylene (bisphenol F residue), 1,4-phenylenecarbonyl-1,4-phenylene, 1,4-phenylenesulfonyl-1,4-phenylene (bisphenol S residue), 1,4-phenylenethio-1,4-phenylene, and 1,4-phenyleneoxy-1,4-phenylene).

The ratio of cross-linking group is 0.01-50 mol %, preferably 0.1-30 mol %, based on the total amount of R¹s. Examples of the cross-linked phosphazene include cross-linked phenoxyphosphazenes, cross-linked tolyloxyphosphazenes, cross-linked xylylphosphazenes, cross-linked tolyloxyxylyloxyphosphazenes, cross-linked phenoxytolyloxyphosphazenes, cross-linked phenoxyxylyloxyphosphazenes and cross-linked phenoxytolyloxyxylylphosphazenes, which are cross-linked by at least one arylene group selected from the above phenylenes, naphthylenes and bisphenol residues.

To avoid kneadability reduction during production of a polyamide resin composition, phosphazene (C) preferably has a melting point of 80-320° C.

The above phosphazenes can be prepared with any known method; the phosphazenes and preparation methods thereof are described in JP-A Nos. 2004-115815 and 2002-114981, for example. The phosphazenes are readily commercially available; commercially available products include FP-100, FP-200, FP-300, FP-306, FP-400, FP-500, FP-800A, FP-800H, FP-800E, FP-900H and FP-1000 (FUSHIMI Pharmaceutical Co., Ltd.); and SPS-100, SPB-100 and SPE-100 (Otsuka Chemical Co., Ltd.).

Phosphazene (C) used in the present invention is preferably added in an amount of 0.01-10 wt %, more preferably 1-5 wt %, based on the weight of a flame-retardant polyamide composition. When the phosphazene (C) content falls within this range, the flame-retardant polyamide composition can exhibit high and stable flame retardancy comparable to UL94V-0, can have high flow ability that allows the composition to be formed into a thin molded article, and can impart sufficient heat resistance during a reflow soldering process of a thin molded article, particularly during a reflow soldering process where high-melting point lead-free solder is used.

[Flame Retardant Synergist (D)]

Flame retardant synergist (D) can be used in the present invention as necessary. This component is added so that a resultant molded article, even a thin molded article, can exert high and stable flame retardancy comparable to UL94V-0, and is particularly effective in applications such as manufacturing of thin and small electric parts. In flame retardancy technology using phosphinate (B) and phosphazene (C), it is important how quickly a carbonized layer (char) is formed on the molded article surface upon burning for oxygen blockage in order to make the article flame retardant. The strength of the resultant carbonized layer is also important; poor strength tends to lead to prolonged burning time, as heated decomposition gas blows out from the article and breaks the carbonized layer before the flame in the article extinguishes. Flame retardant synergist (D) used in the present invention can enhance char formation rate and char strength, whereby even a thin molded article can exhibit high flame retardancy which meets the UL94V-0 requirements.

UL94V-0 flame test will be described. Five test pieces are prepared first. For each test piece, burning time after one application of 10 seconds of a flame is measured, immediately followed by another application of 10 seconds of a flame and subsequent measurement of burning time. For each test piece, burning should stop within 10 seconds after two applications of 10 seconds each of a flame, and total burning time of the first and second test pieces should be within 50 seconds. As used herein “stable flame retardancy” means a state which meets both of the above requirements and where variations in burning time among five test pieces are small (i.e., the difference between maximum burning time and minimum burning time is small) and flame-out time is shorter.

Preferred embodiments of flame retardant synergist (D) used in the present invention are oxides of Groups 3-15 elements of the periodic table. These compounds can be used alone or in combination. In order to enhance flame retardancy, it is effective to increase the surface area of flame retardant synergist, i.e., to reduce the particle size of the flame retardant synergist. Specifically, it is preferable to employ a flame retardant synergist having an average particle diameter of 100 μm or less, preferably 0.05-50 μm, more preferably 0.05-10 μm.

Further, among oxides of Group 3-15 elements, oxides of elements selected from Ti, V, Mn, Fe, Mo, Sn, Zr, Bi, B, Al and Zn are preferable, and oxides of elements selected from Fe, Sn, B, Al and Zn are more preferable. Moreover, Fe₂O₃, SnO₂, zinc borate and boehmite are preferable, and among them, Fe₂O₃, SnO₂ and zinc borate are more preferable for their capability of providing stable flame retardancy.

Flame retardant synergist (D) is contained in an amount of 0.01-10 wt %, preferably 0.1-5 wt %, based on the weight of a flame-retardant polyamide composition. Using flame retardant synergist (D) in an amount falling within this range, stable molding is possible even at high temperatures of 280° C. or higher without causing resin decomposition and, in addition, stable flame retardancy can be ensured at high-level flame retardancy rating comparable to UL94V-0.

[Reinforcement (E)]

A flame-retardant polyamide composition of the present invention may contain reinforcement (E) where necessary. As reinforcement (E), various inorganic fillers in the form of fiber, powder, grain, plate, needle, cloth, mat, etc., can be used alone or in combination.

More specifically, reinforcement (E) may be a powdery or plate-shaped inorganic compound such as silica, silica-alumina, alumina, calcium carbonate, titanium dioxide, talc, Wollastonite, diatomite, clay, kaoline, spherical glass, mica, gypsum, red iron oxide, magnesium oxide or zinc oxide; needle-shaped inorganic compound such as potassium titanate; inorganic fiber such as glass fiber, potassium titanate fiber, metal-coated glass fiber, ceramic fiber, Wollastonite, carbon fiber, metal carbide fiber, metal curing product fiber, asbestos fiber or boron fiber; or organic filler such as aramid fiber or carbon fiber. Among them, fibrous materials are preferable, and glass fibers are more preferable. With glass fiber, moldability is enhanced, and besides, mechanical properties (e.g., tensile strength, flexural strength and flexural modulus) and heat resistance properties (e.g., heat distortion temperature) of a molded article produced from the polyamide composition are improved. The average length of a preferable glass fiber is usually 0.1-20 mm, preferably 0.3-6 mm, and the aspect ratio (L (average fiber length)/D (average fiber outer diameter)) thereof is usually 10 to 5,000, preferably 2,000 to 3,000.

When a fibrous reinforcement is used, it is effective to employ a fibrous material whose cross section has an aspect ratio (major diameter-to-minor diameter ratio) of greater than 1, preferably 1.5-6.0, for suppressing warpage of a molded article.

Further, these fillers may be surface-treated with silane coupling agents or titan coupling agents, e.g., silane compounds such as vinyltriethoxysilane, 2-aminopropyltriethoxysilane or 2-glycidoxypropyltriethoxysilane.

The fibrous filler as reinforcement (E) may be coated with a sizing agent. As such sizing agents, acrylic compounds, acrylic/maleic derivative modified compounds, epoxy compounds, urethane compounds, urethane/maleic derivative modified compounds and urethane/amine modified compounds are preferably used. The surface-treating agent and sizing agent may be used in combination. When used in combination, it enhances compatibility of the fibrous filler with other components in the polyamide composition, whereby appearance and strength characteristics are improved.

Reinforcement (E) is preferably contained in an amount of 0-50 wt %, more preferably 10-45 wt %, based on the weight of a flame-retardant polyamide composition of the present invention.

[Other Additives]

A flame-retardant polyamide composition of the present invention may contain, in addition to the above components, various known additives, such as heat stabilizers, weathering stabilizers, flow ability improvers, plasticizers, thickeners, antistatic agents, mold release agents, pigments, dyes, inorganic or organic fillers, nucleating agents, fibrous reinforcing agents and/or inorganic compounds (e.g., carbon black, talc, clay, mica) in amounts that do not affect the object of the present invention. In the present invention, it is also possible to use additives such as general-purpose ion scavengers; for example, hydrotalcite and zeolite are known. In particular, addition of the fibrous reinforcing agent enhances heat resistance, flame retardancy, rigidity, tensile strength, flexural strength and impact strength of the flame-retardant polyamide composition of the present invention.

The flame-retardant polyamide composition of the present invention may further contain other polymers in amounts that do not affect the object of the present invention; examples of such polymers include polyolefins such as polyethylene, polypropylene, poly-4-methyl-1-pentene, ethylene/1-butene copolymer, propylene/ethylene copolymer, propylene/1-butene copolymer and polyolefin elastomer, polystyrene, polyamide, polycarbonate, polyacetal, polysulfone, polyphenylene oxide, fluororesin, silicone resin, PPS, LCP and Teflon®. In addition to these polymers, modified polyolefins are exemplified. Modified polyolefines are modified with carboxyl group, acid anhydride group, amino group or the like. Examples thereof include modified polyolefine elastomers such as modified polyethylene, modified aromatic vinyl compound/conjugated diene copolymers (e.g., modified SEBS) or hydrogenated products thereof, and modified ethylene/propylene copolymers.

[Preparation Method for Flame-Retardant Polyamide Composition]

A flame-retardant polyamide composition of the present invention may be produced by a known resin kneading method. For example, it is possible to employ a method in which raw materials are mixed using Henschel mixer, V-blender, Ribbon blender or tumble blender; or a method in which the mixture is further melt-kneaded using a single-screw extruder, multi-screw extruder, kneader or banbury mixer and then the kneaded product is granulated or pulverized.

[Flame-Retardant Polyamide Composition]

A flame-retardant polyamide composition of the present invention preferably contains 20-80 wt % polyamide resin (A), more preferably 40-60 wt % polyamide resin (A). When the amount of polyamide resin (A) is 20 wt % or more, the flame-retardant polyamide composition has sufficient toughness. When the amount of polyamide resin (A) is 80 wt % or less, the flame-retardant polyamide composition can contain a sufficient amount of flame retardant, thereby obtaining flame retardancy.

A flame-retardant polyamide composition of the present invention preferably contains 5-30 wt % phosphinate (B), more preferably 10-20 wt % phosphinate (B). When the amount of phosphinate (B) is 5 wt % or more, sufficient flame retardancy can be obtained. When the amount of phosphinate (B) is 30 wt % or less, flow ability reduction during extrusion molding and toughness reduction do not occur.

A flame-retardant polyamide composition of the present invention preferably contains 0.01-10 wt % phosphazene (C), more preferably 1-5 wt % phosphazene (C). When the amount of phosphazene (C) is 0.01 wt % or more, both flame retardancy and flow ability can be ensured. When the amount of phosphazene (C) is 10 wt % or less, mechanical properties (e.g., toughness) and heat resistance during a reflow soldering process can be ensured.

Further, a flame-retardant polyamide composition of the present invention preferably contains 0.05-10 wt % flame retardant synergist (D), more preferably 0.1-5 wt % flame retardant synergist (D). When the amount of flame retardant synergist (D) is 0.05 wt % or more, sufficient flame retardancy can be imparted. When the amount of flame retardant synergist (D) is 10 wt % or less, the toughness of the flame-retardant polyamide composition does not decrease.

Moreover, a flame-retardant polyamide composition of the present invention preferably contains 0-50 wt % reinforcement (E), preferably 20-45 wt % reinforcement (E). When the amount of reinforcement (E) is 50 wt % or less, the flow ability of the flame-retardant polyamide composition does not decrease during extrusion molding.

A flame-retardant polyamide composition of the present invention can further contain the other additive(s) described above in amounts that do not affect the object of the present invention.

A flame-retardant polyamide composition of the present invention meets the UL 94 rating of V-0. In addition, the reflow heat resistance temperature of the flame-retardant polyamide composition, as measured after subjected to moisture adsorption for 96 hours at 40° C. and at relative humidity of 95%, is 250-280° C., more preferably 255-280° C. The breaking energy of the flame-retardant polyamide composition of the present invention, which is the mechanical property indicative of toughness, is 40-70 mJ, preferably 50-70 mJ. The flow length of the flame-retardant polyamide composition, upon injection molding of the resin into a bar-flow mold, is 40-80 mm, preferably 45-70 mm. As described above, the flame-retardant polyamide composition of the present invention has excellent heat resistance sufficient to meet the requirement of surface mounting using lead-free solder, as well as toughness comparable to or greater than that of Nylon 46. In addition, the flame-retardant polyamide composition has high melt flow ability, high flame retardancy and high molding stability and is particularly suitable for manufacture of electric parts.

[Molded Article and Electric Parts Material]

A flame-retardant polyamide composition of the present invention can be formed into any article by a known molding method such as compaction molding, injection molding, or extrusion molding. In particular, extrusion molding is effective. Specifically, it is possible to suppress oxidative decomposition of flame retardant and polyamide resin by performing extrusion molding under inert gas (e.g., nitrogen, argon or helium) atmosphere at a flow rate of 0.1-10 ml/min. This makes it possible to ensure thermal stability in the flame-retardant polyamide composition heated in a molding machine.

A flame-retardant polyamide composition of the present invention is excellent in molding stability, heat resistance and mechanical properties and thus can be used in applications where these characteristics are required, or in the field of precise molding. Specific examples include electric parts such as automobile electrical components, circuit breakers, connectors and LED reflection materials, and molded articles such as coil bobbins and housings.

### EXAMPLES

Hereinafter, the present invention will be detailed with reference to Examples, which however shall not be construed as limiting the scope of the present invention. In Examples and Comparative Examples, measurements and evaluations of physical properties are made as described below.

[Intrinsic Viscosity [η]]

Intrinsic viscosity was measured in accordance with JIS K6810-1977. Sample solution was prepared by dissolving 0.5 g of polyamide resin in 50 ml of 96.5% sulfuric acid solution. The flow-down time (sec) of the sample solution was measured using a Ubbelohde viscometer at 25±0.05° C. Intrinsic viscosity [η] was then calculated using the following equation.

[η]=ηSP/[C(1+0.205ηSP)]

ηSP=(t−t0)/t0

[η]: intrinsic viscosity (dl/g)

ηSP: specific viscosity

C: sample concentration (g/dl)

t: sample flow-down time (sec)

t0: flow-down time (sec) of sulfuric acid (blank)

[Melting Point (Tm)]

The melting point of the polyamide resin was measured using DSC-7 (PerkinElmer, Inc.). The polyamide resin was held at 330° C. for 5 minutes, cooled to 23° at a rate of 10° C./min, and then heated at a heating rate of 10° C./min. The endothermic peak based on the melting of the polyamide resin was employed as the melting point.

[Flammability Test]

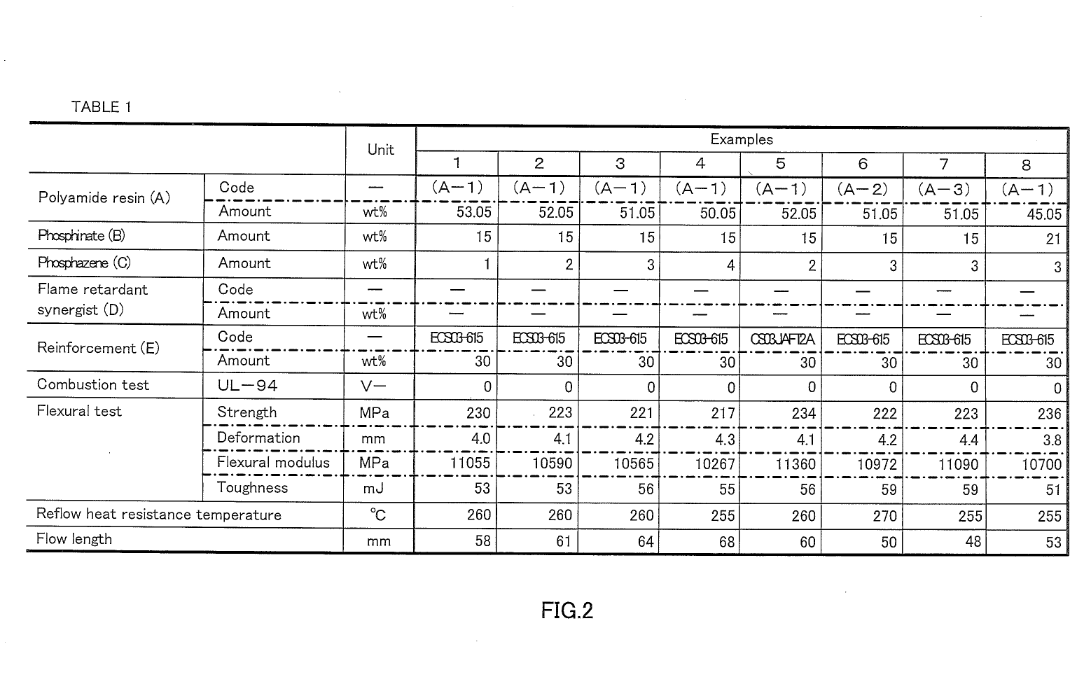

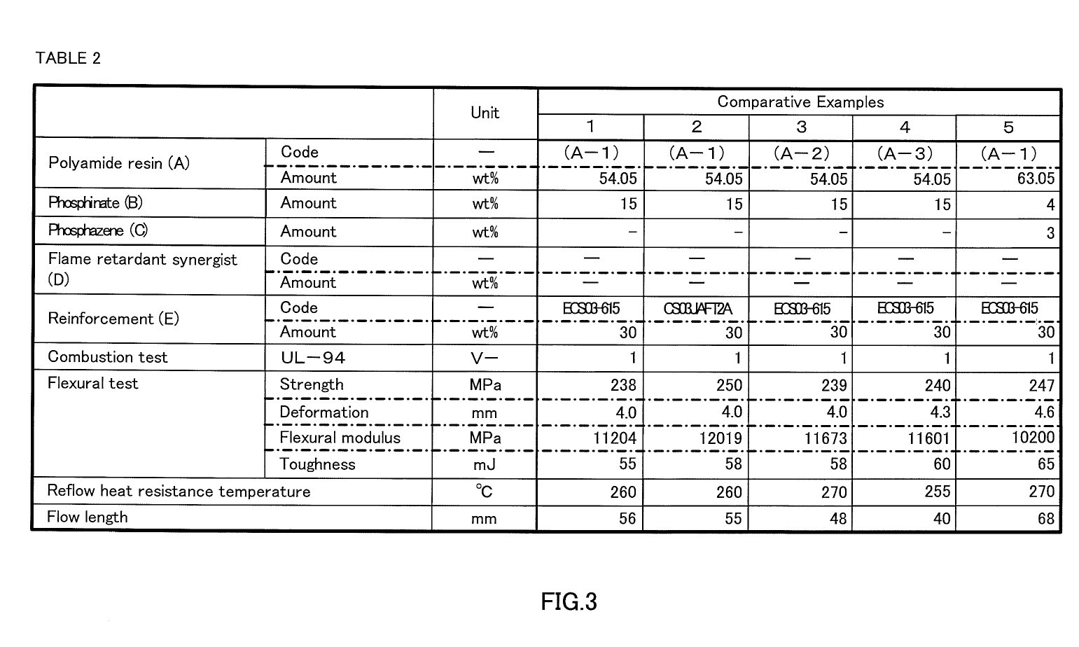

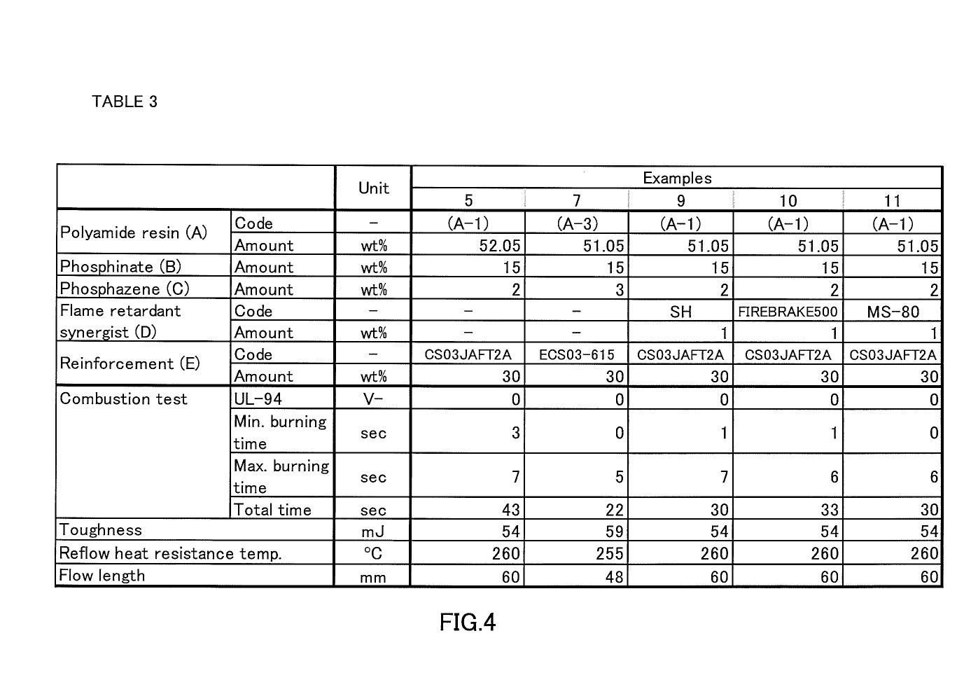

Test pieces (thickness: 1/32 inch, width: ½ inch, length: 5 inch) were prepared by injection molding of polyamide compositions formulated from components shown in Table 1 (FIG. 2), Table 2 (FIG. 3) and Table 3 (FIG. 4). Vertical combustion tests were performed on the prepared test pieces to evaluate flame retardancy in accordance with the UL94 standard (UL Test No. UL94, Jun. 18, 1991).

For five test pieces, the minimum burning time, maximum burning time, and total burning time were recorded. The used molding machine, cylinder temperature, and mold temperature are shown below.

Molding machine: TUPARL TR40S3A (Sodick Plustech Co., Ltd.)

Cylinder temperature: polyamide resin melting point (Tm) plus 10° C.

Mold temperature: 120° C.

[Reflow Resistance Test]

Test pieces (length: 64 mm, width: 6 mm, thickness: 0.8 mm) prepared by injection molding of polyamide compositions formulated from components shown in Table 1 (FIG. 2), Table 2 (FIG. 3) and Table 3 (FIG. 4) were subjected to humidity conditioning at 40° C. and a relative humidity of 95% for 96 hours. The used molding machine, cylinder temperature, and mold temperature are shown below.

Molding machine: TUPARL TR40S3A (Sodick Plustech Co., Ltd.)

Cylinder temperature: polyamide resin melting point (Tm) plus 10° C.

Mold temperature: 100° C.

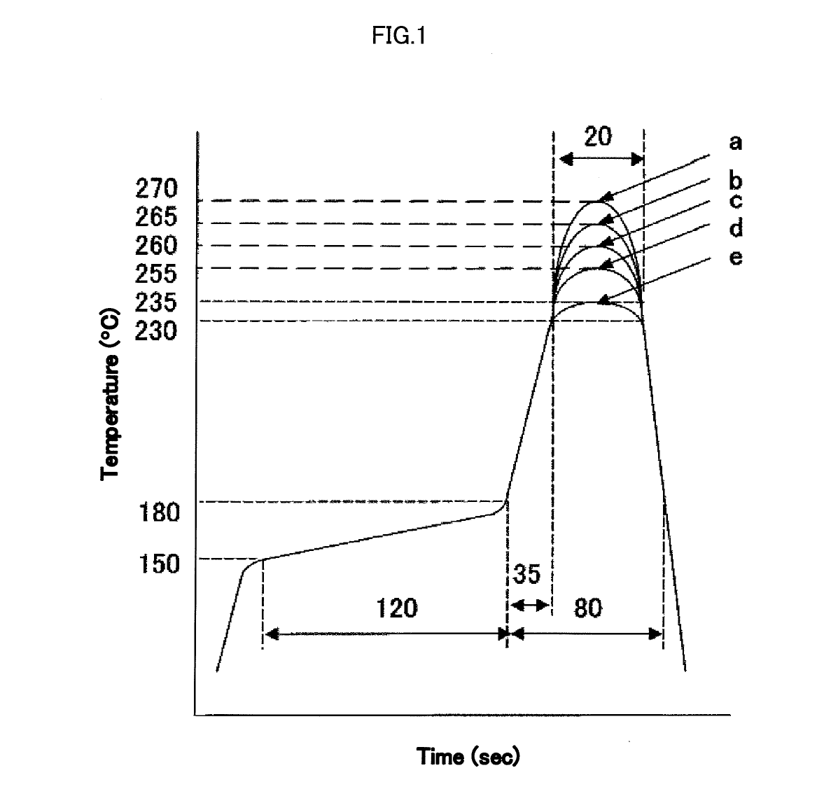

A reflow soldering process was performed in accordance with the temperature profile shown in FIG. 1 using an air reflow soldering machine (AIS-20-82-C, manufactured by EIGHTECH TECTRON CO., LTD.) The conditioned test piece was placed on a 1 mm-thick glass epoxy substrate. A temperature sensor was placed on the substrate to measure a temperature profile. Referring to FIG. 1, the test piece was heated to 230° C. at a predetermined heating rate, heated to predetermined set temperatures (“a”: 270° C., “b”: 265° C., “c”: 260° C., “d”: 255° C., or “e”: 235° C.) over 20 seconds, and cooled back to 230° C. From the above reflow process the highest set temperature was found at which the test piece was not molten and no blister was observed on its surface. This highest set temperature was defined as a reflow heat resistance temperature. In general, test pieces subjected to moisture absorption tend to have lower reflow heat resistance temperatures than completely-dried ones. Moreover, reflow heat resistance tends to decrease with decreasing polyamide resin-to-flame retardant ratio.

[Flexural Test]

Test pieces (length: 64 mm, width: 6 mm, thickness: 0.8 mm) were prepared by injection molding of polyamide compositions formulated from components shown in Table 1 (FIG. 2), Table 2 (FIG. 3) and Table 3 (FIG. 4) under the condition described below. Subsequently, the test pieces were allowed to stand at 23° C. for 24 hours under nitrogen gas atmosphere. Using a flexure tester (AB5, manufactured by NTESCO), flexural tests were performed at 23° C. and relative humidity of 50% under the following conditions: span=26 mm, flexure rate=5 mm/min. In this way flexural strength, strain amount and elasticity were measured to find energy required for breaking the test piece (toughness).

The used molding machine, cylinder temperature, and mold temperature are as follows.

Molding machine: TUPARL TR40S3A (Sodick Plustech Co., Ltd.)

Cylinder temperature: polyamide resin melting point (Tm) plus 10° C.

Mold temperature: 100° C.

[Flow Length Test (Flow Ability)]

Polyamide compositions formulated from components shown in Table 1 (FIG. 2), Table 2 (FIG. 3) and Table 3 (FIG. 4) were injection-molded under the following condition using a bar-flow mold (width=10 mm, thickness=0.5 mm) to measure their flow length (mm) in the mold.

Injection molding machine: TUPARL TR40S3A (Sodick Plustech Co., Ltd.)

Injection pressure: 2,000 kg/cm²

Cylinder set temperature: polyamide resin melting point (Tm) plus 10° C.

Mold temperature: 120° C.

[Generated Gas Amount During Molding]

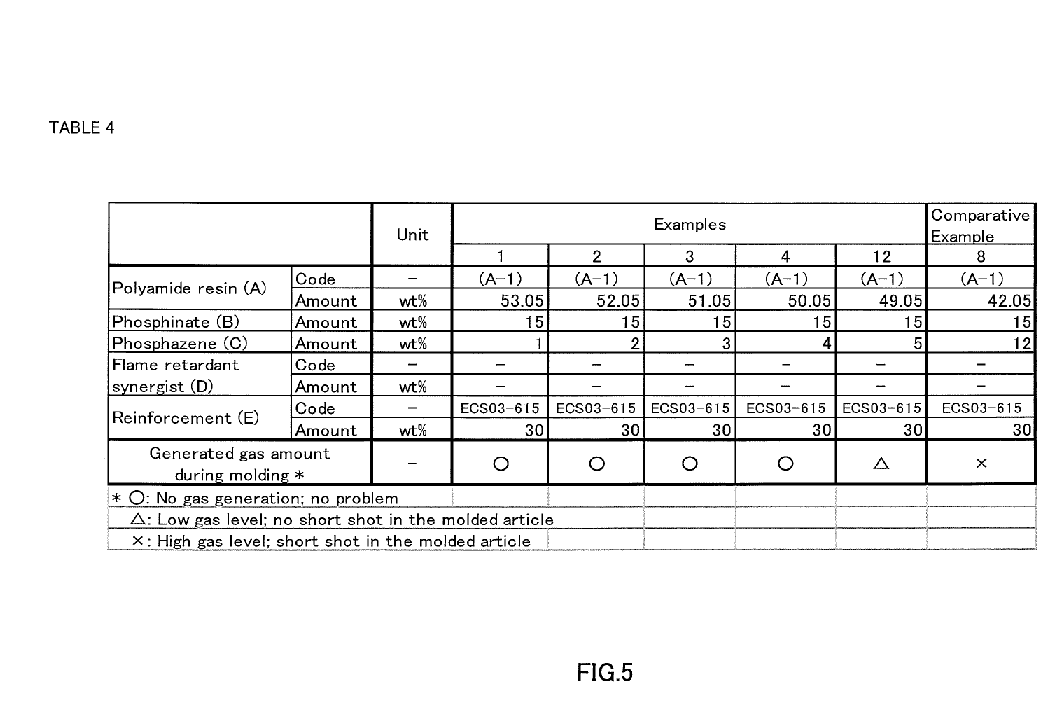

The amount of gas generated during molding was visually evaluated for polyamide compositions formulated from components shown in Table 4 (FIG. 5) upon manufacturing of molded articles in the above flexural tests. Samples which generated no gas are ranked as “∘”, samples which generated slight amount of gas but caused no “short shot” of the molded article are ranked as “Δ”, and samples which generated large amount of gas and caused “short shot” are ranked as “x.”

Polyamide resin (A), phosphinate (B), phosphazene (C), flame retardant synergist (D) and reinforcement (E) used in Examples and Comparative Examples are described below.

[Polyamide Resin (A)]

### (Polyamide Resin (A-1))

Composition: Dicarboxylic acid unit (terephthalic acid: 62.5 mol % and adipic acid: 37.5 mol %), Diamine unit (1,6-diaminohexane: 100 mol %)

Intrinsic viscosity [η]: 0.8 dl/g

Melting point: 320° C.

[Polyamide Resin (A-2)]

Composition: Dicarboxylic acid unit (terephthalic acid: 62.5 mol % and adipic acid: 37.5 mol %), Diamine unit (1,6-diaminohexane: 100 mol %)

Intrinsic viscosity [η]: 1.0 dl/g

Melting point: 320° C.

[Polyamide Resin (A-3)]

Composition: Dicarboxylic acid unit (terephthalic acid: 55 mol % and adipic acid: 45 mol %) Diamine unit (1,6-diaminohexane: 100 mol %)

Intrinsic viscosity [η]: 1.0 dl/g

Melting point: 310° C.

[Phosphinate (B)]

EXOLIT OP1230 (Clariant (Japan) K.K.) Phosphorus content=23.8 wt %

[Phosphazene (C)]

Cyclic phenoxyphosphazene (compound having general formula (1), where m is 3)

Melting point=110° C.

Phosphorus content=13 wt %

[Flame Retardant Synergist (D)]

SnO₂: Tin (IV) oxide SH (Nihon Kagaku Sangyo Co., Ltd.), average particle size=2.5 μm

Fe₂O₃: MS-80 (Tone Sangyo K.K.), average particle size=0.3 μm

Zinc borate: FIREBREAK500 (2ZnO.3B₂O₃) (Borax)

[Reinforcement (E)]

Glass fiber: ECS03-615 (Central Glass Co., Ltd.)

Glass fiber: CS 03JA FT2A (Owens Corning Japan)

In addition to the above components, talc (Hifiller #100 (whiteness 95), Matsumura Sangyo K.K.) and calcium montanate (CAV102, Clariant (Japan) K.K.) were formulated in amounts of 0.7 wt % and 0.25 wt %, respectively, based on the total amount of polyamide resin (A), phosphinate (B), phosphazene (C), flame retardant synergist (D), reinforcement (E), talc, and calcium montanate.

### Examples 1-12 and

### Comparative Examples 1-5, and 8

The above components were mixed in proportions shown in Table 1 (FIG. 2), Table 2 (FIG. 3) and Table 3 (FIG. 4), and loaded in a vent-equipped twin-screw extruder which is set to 320° C., and melt-kneaded to produce respective polyamide compositions in the form of pellet. Physical properties evaluated for the obtained flame-retardant polyamide compositions are shown in Examples 1-12, Comparative Examples 1-5 and 8 of Tables 1-4.

### Comparative Example 6

A formulation consisting of 38.05 wt % polyamide resin (A-1), 30.4 wt % phosphazene (C) (equivalent to phosphazene (C) in Example 3 in terms of phosphorus content), 30 wt % reinforcement (E) (ECS03-615), 0.7 wt % talc (Hifiller #100 (whiteness 95)) and 0.25 wt % calcium montanoate (CAV102) was loaded in a vent-equipped twin-screw extruder in the same manner as described above in an attempt to prepare a pellet resin composition. However, pellet composition preparation failed because only phosphazene was dissolved and thus melting of polyamide resin and melt-kneading with the other components were not effected.

### Comparative Example 7

A formulation consisting of 26.05 wt % polyamide resin (A-1), 40 wt % phosphinate (B), 3 wt % phosphazene (C), 30 wt % reinforcement (E) (ECS03-615), 0.7 wt % talc (Hifiller #100 (whiteness 95)) and 0.25 wt % calcium montanoate (CAV102) was loaded in a vent-equipped twin-screw extruder in the same manner as described above in an attempt to prepare a pellet resin composition. However, pellet composition preparation failed due to the presence of a large amount of phosphinate, resulting in poor melt-kneading with polyamide resin.

The present application claims the priority of Japanese Patent Application No. 2007-244695 filed on Sep. 21, 2007, the entire contents of which are herein incorporated by reference.

### INDUSTRIAL APPLICABILITY

Even without containing a halogen flame retardant, the flame-retardant polyamide composition of the present invention is excellent in mechanical properties (e.g., toughness), heat resistance during a during a reflow soldering process, flow ability and thermal stability during molding. The flame-retardant polyamide composition is particularly excellent in flame retardancy when formed in a thin molded article. In particular, the flame-retardant polyamide composition is suitable in the electrical fields where an electrical part such as a thin and fine pitch connector is fabricated and surface-mounted using a high-melting point solder, or in the field of precise molding.

1. A flame-retardant polyamide composition comprising:
20-80 wt % polyamide resin (A);
5-30 wt % phosphinate (B);
0.01-10 wt % phosphazene (C); and
0-50 wt % reinforcement (E).

2. The flame-retardant polyamide composition according to claim 1, wherein polyamide resin (A) has a melting point of 280-340° C.

3. The flame-retardant polyamide composition according to claim 1, wherein phosphazene (C) is at least one phosphazene selected from a cyclic phosphazene having the following formula (1), a linear phosphazene having the following formula (2), and at least one phosphazene obtained by cross-linking the cyclic phosphazene or the linear phosphazene with a cross-linking group 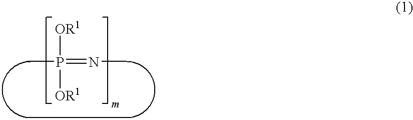
(where m denotes an integer of 3-25; and R¹s are the same or different and each denote an aryl group or alkylaryl group, and the ratio of alkylaryl group is 0.1-100 mol % based on the total amount of R¹s) 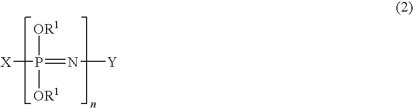
(where n denotes an integer of 3-10,000; X denotes —N═P(OR¹)₃ or —N═P(O)OR¹; Y denotes —P(OR¹)₄ or —P(O)(OR¹)₂; and R¹s are the same or different and each denote an aryl group or alkylaryl group, and the ratio of alkylaryl group is 0.1-100 mol % based on the total amount of R¹s).

4. The flame-retardant polyamide composition according to claim 1, further comprising 0.01-10 wt % flame retardant synergist (D),
wherein flame retardant synergist (D) is one or more oxides selected from oxides of Groups 3-15 elements of the periodic table.

5. The flame-retardant polyamide composition according to claim 4, wherein flame retardant synergist (D) has an average particle diameter of 100 μm or less.

6. The flame-retardant polyamide composition according to claim 4, wherein flame retardant synergist (D) is at least one compound selected from Fe₂O₃, SnO₂ and zinc borate.

7. The flame-retardant polyamide composition according to claim 1, wherein phosphinate (B) is a flame retardant which contains a phosphinate having general formula (3) and/or bisphosphinate having formula (4) and/or polymer thereof 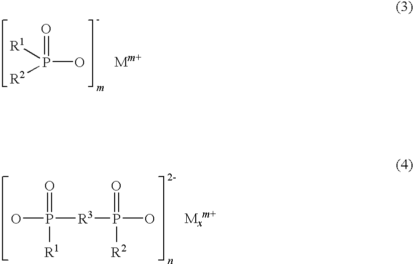
(where R¹ and R² are the same or different and each denote a linear or branched C₁-C₆ alkyl and/or aryl group; R³ denotes a linear or branched C₁-C₁₀ alkylene group, C₆-C₁₀ arylene group, C₆-C₁₀ alkylarylene group or C₆-C₁₀ arylalkylene group; M denotes Mg, Ca, Al, Sb, Sn, Ge, Ti, Zn, Fe, Zr, Ce, Bi, Sr, Mn, Li, Na, K and/or protonated nitrogen base; m denotes an integer of 1-4; n denotes an integer of 1-4; and x denotes an integer of 1-4).

8. The flame-retardant polyamide composition according to claim 1, wherein polyamide resin (A) contains multifunctional carboxylic acid unit (a-1) and multifunctional amine unit (a-2) having 4-25 carbon atoms, the multifunctional carboxylic acid unit (a-1) being composed of 60-100 mol % terephthalic acid unit, 0-30 mol % multifunctional aromatic carboxylic acid unit other than terephthalic acid, and/or 0-60 mol % multifunctional aliphatic carboxylic acid unit having 4-20 carbon atoms.

9. The flame-retardant polyamide composition according to claim 1, wherein polyamide resin (A) has an intrinsic viscosity [η] of 0.5-0.95 dl/g as measured in 25° C. concentrated sulfuric acid.

10. The flame-retardant polyamide composition according to claim 1, wherein reinforcement (E) is a fibrous material.

11. The flame-retardant polyamide composition according to claim 1, wherein reinforcement (E) contains a fibrous material in which the aspect ratio of a cross section is greater than 1.

12. A molded article obtained by molding of the flame-retardant polyamide composition according to claim 1.

13. A method of obtaining a molded article comprising:
injection molding of the flame-retardant polyamide composition according to claim 1 under inert gas atmosphere.

14. An electric part obtained by molding of the flame-retardant polyamide composition according to claim 1.

15. The flame-retardant polyamide composition according to claim 1, wherein phosphazene (C) is at least one cyclic phosphazene having general formula (1) and/or at least one linear phosphazene having general formula (2). 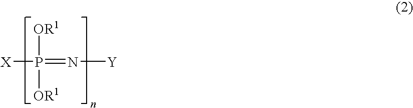
(where m denotes an integer of 3-25; and R¹s each denote a phenyl group which optionally has a substituent).
